(19) United States
(12) Patent Application Publication
(10) Pub. No.: US 2006/0248327 A1
(43) Pub. Date: Nov. 2, 2006

(54) Computer rapid boot system and method

(75) Inventors: An-Sheng Chang, Taipei Hsien (TW); Chan-Shiang Chen, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: GIGA-BYTE TECHNOLOGY CO., LTD.

(21) Appl. No.: 11/115,154

(22) Filed: Apr. 27, 2005

(51) Int. Cl. G06F 9/00

(52) U.S. Cl. 713/2

(57) ABSTRACT

A computer rapid boot system includes a transmission interface, a volatile memory for storing computer boot information, an interface converter for converting the format of a transmission signal between the transmission interface and the volatile memory, a main memory and a central processing unit. Furthermore, when the computer is booted, the central processing unit can read the computer boot information stored in the volatile memory via the transmission interface, and then enable the computer boot information to be stored in the main memory for increasing the computer boot speed.

### BACKGROUND OF THE INVENTION

1. Field of the Invention

The present invention relates to a computer rapid boot system and method and, more particularly, to a computer rapid boot system and method for loading the boot information into a main memory by designating a computer boot device.

2. Description of the Related Art

In general, a computer system can be a personal computer, a notebook computer or a server host, including a plurality of kinds of access devices, such as hard-disk drives, disk drives, optical disk drives, Com Ports, PS2 Ports, VGAs, LPT Ports, or IDEs, etc.

A typical computer boot manner is disclosed in TW 588284 published on 21 May 2004. In TW 588284, the computer system will be booted in BIOS and the motherboard is set to designate the access device that stores the operating system with the computer boot information as a computer boot device.

Of the above-mentioned access devices, the hard-disk drive is the access device that can be accessed most rapidly. Thus, in the present computer system, an operating system, such as Microsoft Windows, IBM OS2 system or LINUx, etc., is installed on the hard-disk drive, to enable the operating system to boot or shutdown the computer.

However, the computer boot method of TW 588284, spends a long time waiting to access data information or searching the hard-disk drive when the operating system is booting, so that the process is a slow one.

When the operating system is installed on the hard disk drive and has been used for a long time, the amount of information stored on the hard drive will slow down the operating speed of the hard disk drive. If the hard-disk drive has a large amount of information stored on it, the boot files, the entry files, the active files and the relation files of the computer boot program will also have been spread throughout the hard-disk drive. Consequently, as more information is stored on the hard drive, searching and accessing data in the hard-disk drive becomes slower. This causes the computer boot process to slow and takes a longer to time to be completed. Even if the speed of the motherboard, CPU is memory is increased, the hard-disk drive will still belong to a slowed access device.

Another restore software application for booting and shutting down a computer is disclosed in TW 591395 published on 11 Jun. 2004. When the computer is shut down the computer system creates an image file and stores the image file onto the hard-disk drive. When the computer system is booted, the image file stored in the hard-disk drive is restored into the memory, thereby avoiding the longer access action of the boot file for computer rapid boot. The advantage of the restore software is in that it doesn't need to provide the memory power in the shutdown status. However, the disadvantage of the restore software method is that it takes a long time to access data from the hard-disk drive, causing the boot speed to be reduced.

### SUMMARY OF THE INVENTION

The present invention provides a computer rapid boot system and method for accessing computer boot information via the volatile memory or the main memory so as to obtain a faster computer boot speed. Furthermore, the present invention eliminates the problem explained above of the prior art.

The present invention of a computer rapid boot system includes a transmission interface, a volatile memory, a power source, an interface converter, a main memory and a central processing unit. The volatile memory is for storing computer boot information. The power source is for providing power to the volatile memory. The interface converter is for converting the format of a transmission signal between the transmission interface and the volatile memory. The central processing unit is for reading the computer boot information stored in the volatile memory via the transmission interface and the interface converter so as to control the computer boot. The central processing unit then enables the computer boot information to be stored in the main memory so as to allow a computer boot.

Another aspect of the invention is a computer rapid boot system that includes a plurality of transmission interfaces, a disk array controller, a volatile memory, a power source, an interface converter, a main memory and a central processing unit. The disk array controller is for controlling the signal transmission of the transmission interfaces. The volatile memory is for storing computer boot information. The power source is for providing power to the volatile memory. The interface converter is for providing the format conversion of a transmission signal between the volatile memory and the disk array controller. The central processing unit is for reading the computer boot information stored in the volatile memory via the transmission interfaces and the disk array controller, so as to control the computer boot, enabling the computer boot information to be stored in the main memory so as to allow the computer to be booted.

Yet a further aspect of the invention is a computer rapid boot method including the following steps: providing a volatile memory and a power source to store computer boot information; providing an interface converter for a format conversion of a transmission signal between the volatile memory and a transmission interface; reading the computer boot information stored in the volatile memory via the transmission interface and the interface converter, enabling the computer boot information to be stored in the main memory; and accessing the computer boot information stored in the main memory to boot the computer.

An additional aspect of the invention is a computer rapid boot method including the following steps: providing a volatile memory and a power source to store computer boot information; providing an interface converter for a format conversion of a transmission signal between the volatile memory and a disk array controller, wherein the disk array controller controls the signal transmission of a plurality of transmission interfaces; reading the computer boot information stored in the volatile memory via the transmission interfaces, the disk array controller and the interface converter, and then enabling the computer boot information to be stored in the main memory; and executing the computer boot information stored in the main memory to boot the computer.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a block diagram of a first embodiment of a computer rapid boot system used in accordance with the present invention.

FIG. 2 is a block diagram of a second embodiment of the computer rapid boot system used in accordance with the present invention.

FIG. 3 is a flowchart of steps performed in accordance with one preferred embodiment of the present invention for booting a computer.

FIG. 4 is a flowchart of steps according to one embodiment of the present invention for shutting down a computer.

FIG. 5 is a flowchart of steps according to another embodiment of the present invention for shutting down a computer.

### DETAILED DESCRIPTION OF THE EMBODIMENTS

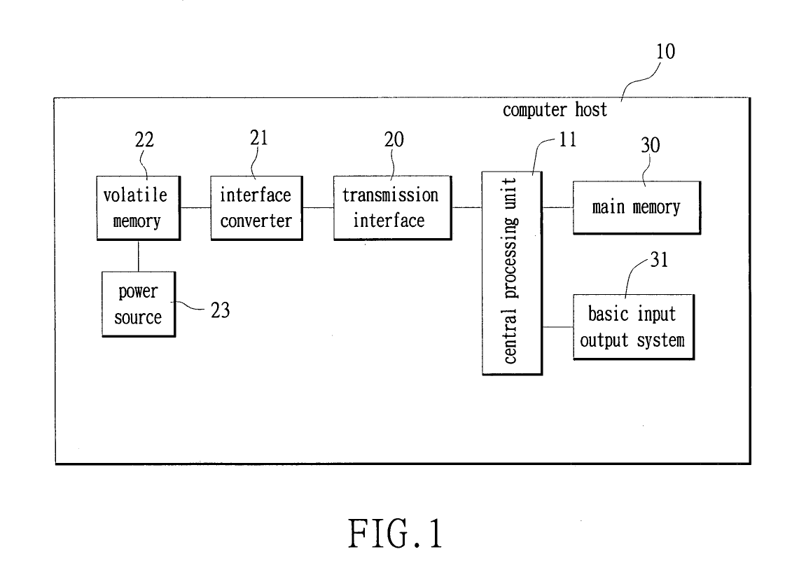

FIG. 1 illustrates a computer rapid boot system in accordance with a first embodiment of the present invention. Some of the elements of a computer host, as indicated by the general reference character 10, configured to support the present invention, are shown in FIG. 1. The computer host 10 includes a central processing unit (CPU) 1 1, a transmission interface 20, an interface converter 21, a volatile memory 22, a power source 23, a main memory 30 and a basic input output system (BIOS) 31. The CPU 11 is provided for controlling data transmission between the volatile memory 22 and the main memory 30. The present invention utilizes the memory with the fastest access speed as the computer boot device for an operating system to rapidly boot the computer, thereby solving the conventional disadvantage of the hard disk drive with a slower access speed.

In this embodiment the volatile memory 22 stores the information that is needed to boot the computer and is used because its access speed is faster than that of the non-volatile memory. The computer boot information stored in the volatile memory 22 includes a plurality of boot files, entry files, active files or relation files of the operating system (such as Windows, OS2 or Linux) and can also be a boot image file. The boot image file is transformed according to an action program, data or a distributed address, or the status of related information of the main memory 30 in the computer boot status. Furthermore, when the computer is booted, the boot image file can be directly restored to the original status in the main memory 30. The volatile memory 22 can be a dynamic random access memory (DRAM).

In order to satisfy the requirements of the computer rapid boot, the CPU 11 accesses the data information of the volatile memory 22 through the transmission interface 20. The transmission interface 20 is a serial ATA (SATA) interface or a PCI-express (PCI-E) interface which provide a rapid data transmission. The interface converter 21 is for providing format conversion of the transmission signal between the transmission interface 20 and the volatile memory 22, so that the CPU 11 can rapidly access data stored in the volatile memory 22.

Additionally, in order to ensure that the volatile memory 22 is not affected by shutting down the computer, causing the data stored in the volatile memory 22 to be lost, the power source 23 provides sufficient power for the volatile memory 22 to retain the data when the computer shuts down. The power source 23 of the present invention is acquired through 5 Vsb (standing by) power of a power supply.

The main memory 30 is used for enabling the CPU 11 to access the executing program or information. When booting the computer, the main memory 30 can store the computer boot information. The main memory 30 can be a DRAM module, a DDRAM module or a RAM BUS module.

When booting a conventional computer, the BIOS will designate one of the access devices with a lower access speed (such as a disk drive, a hard-disk drive, an optical-disk drive or an Internet card, etc.), to act as a computer boot device. In the present invention, the volatile memory 22 is designated as a computer boot device by the BIOS 31. When booting the computer, the CPU 11 will read the computer boot information stored in the volatile memory 22, and enable the computer boot information to be stored in the main memory 30. It will finally execute the computer boot information to finish booting the computer. Therefore, by rapidly accessing the memory the computer boot speed will be raised.

In addition, an interface card comprised of the volatile memory 22 and the interface converter 21 can be inserted into the PCI-E interface of the computer. Alternatively, the volatile memory 22 and the interface converter 21 can be built-in to the motherboard to connect to a serial ATA (SATA) interface.

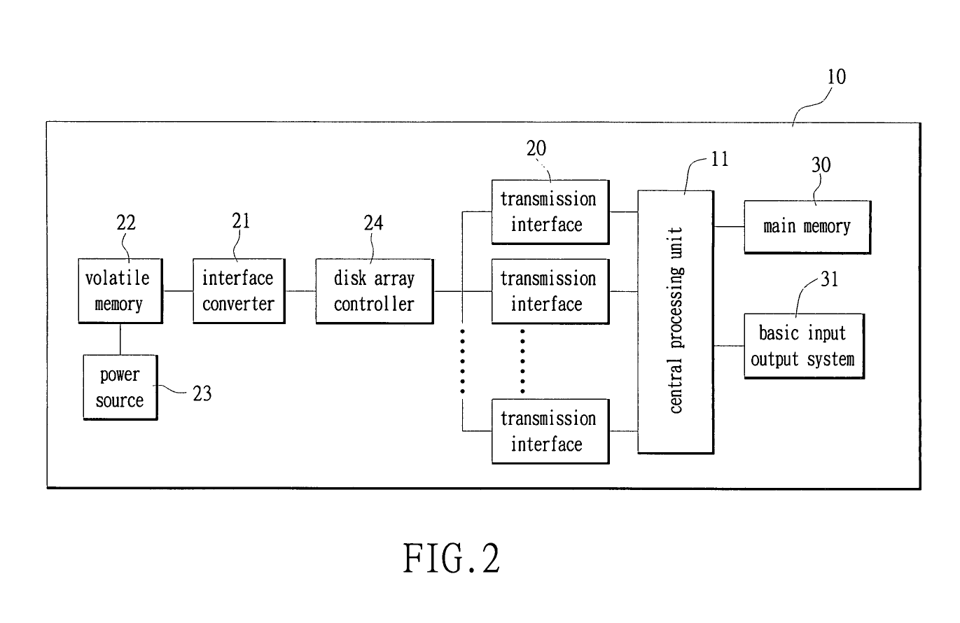

FIG. 2 illustrates a computer rapid boot system in accordance with a second embodiment of the present invention. In the second embodiment the transmission technique of redundant array of independent disks is used to separate information into a plurality of parts for simultaneously transmission, thereby increasing the data accessing speed. In FIG. 2, a plurality of transmission interfaces 20 are used, and a disk array controller 24 controls the signal transmission of the transmission interfaces 20. The interface converter 21 provides format conversion for the transmission signal between the volatile memory 22 and the disk array controller 24. Therefore, the computer boot speed of the second embodiment is faster than that of the first embodiment.

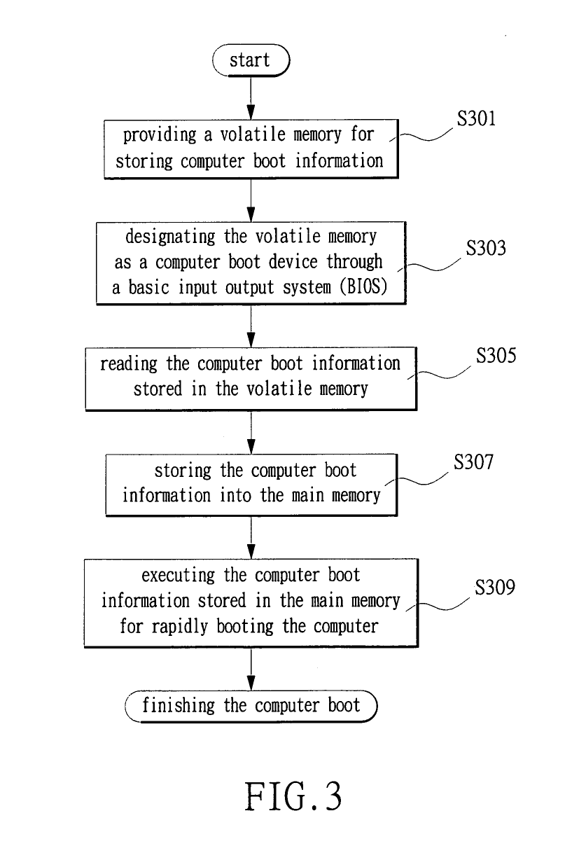

FIG. 3 is a flowchart of the steps performed in accordance with the preferred embodiment of the present invention for booting a computer. The flowchart includes the following steps: providing a volatile memory 22 for storing computer boot information (S301); designating the volatile memory 22 as a computer boot device through a basic input output system (BIOS) (S303); reading the computer boot information stored in the volatile memory 22 via the CPU 11 (305); storing the computer boot information into the main memory 30 (S307); and finally, executing the computer boot information stored in the main memory 30 for rapidly booting the computer (S309).

In the present invention, the computer boot information can be a plurality of boot files. However, the general computer boot information will be changed as the status of the computer interior installation or the software used on the computer changes. For example, the computer boot information will change its active files or relation files when installing new software or new hardware, or when renewing the operating system.

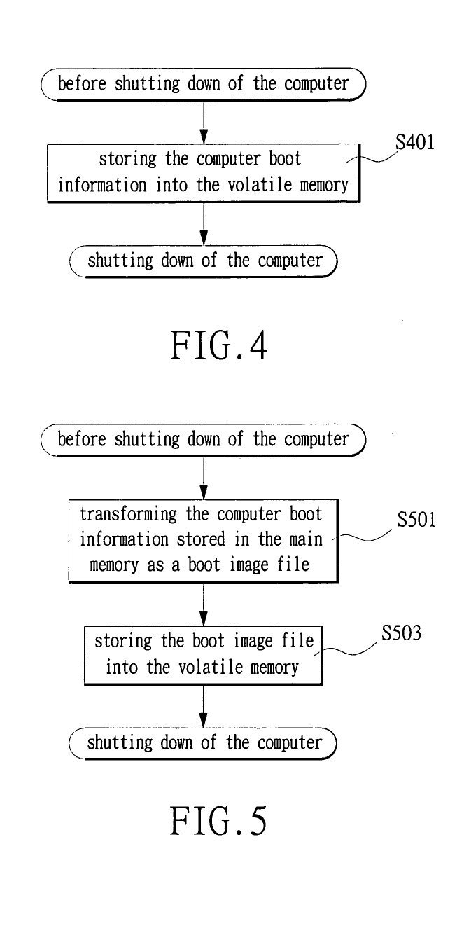

FIG. 4 is a flowchart of the steps according to one embodiment of the present invention for shutting down the computer. The plurality of boot files, entry files, active files or relation files of the operating system will be stored into the volatile memory 22 before shutting down the computer (S401). Thus, the changed computer boot information will be executed the next time the computer is booted, thereby achieving a faster computer boot.

FIG. 5 is a flowchart of the steps according to another embodiment of the present invention for shutting down the computer. The computer boot information stored in the main memory 30 will be transformed as a boot image file before the computer shuts down (S501), then the boot image file is stored into the volatile memory 22 (S503). Thus, the computer boot information in the boot image file will be restored into the main memory 30, thereby bypassing the step of executing the computer boot information of the hard disk drive and booting the computer more rapidly.

There has thus been described a new, novel and heretofore unobvious computer rapid boot system and method, which eliminates the aforesaid problem of the prior art. Furthermore, those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A computer rapid boot system comprising:
a transmission interface;
a volatile memory for storing computer boot information;
a power source for providing power to the volatile memory;
an interface converter for providing format conversion of a transmission signal between the transmission interface and the volatile memory;
a main memory; and
a central processing unit for reading the computer boot information stored in the volatile memory via the transmission interface and the interface converter so as to control the booting of the computer, and enable the computer boot information to be stored in the main memory.

2. The computer rapid boot system of claim 1, wherein the transmission interface is a serial ATA (SATA) interface or a PCI-express (PCI-E) interface.

3. The computer rapid boot system of claim 1, wherein the volatile memory is a dynamic random access memory (DRAM).

4. The computer rapid boot system of claim 1, wherein the computer boot information includes a plurality of boot files, entry files, active files or relation files of an operating system.

5. The computer rapid boot system of claim 1, wherein the boot information is a boot image file.

6. The computer rapid boot system of claim 5, wherein the computer boot information stored in the main memory is transformed into the boot image file according to the status of the computer boot.

7. The computer rapid boot system of claim 1, further comprising a basic input output system (BIOS) for designating the volatile memory as a computer boot device.

8. A computer rapid boot system comprising:
a plurality of transmission interfaces;
a disk array controller for controlling the signal transmission of the transmission interfaces;
a volatile memory for storing computer boot information;
a power source for providing power to the volatile memory;
an interface converter for providing format conversion of a transmission signal between the volatile memory and the disk array controller;
a main memory; and
a central processing unit for reading the computer boot information stored in the volatile memory via the transmission interfaces and the disk array controller so as to control the booting of the computer, and then enabling the computer boot information to be stored in the main memory.

9. The computer rapid boot system of claim 8, wherein the transmission interface is a serial ATA (SATA) interface or PCI-express (PCI-E) interface.

10. The computer rapid boot system of claim 8, wherein the volatile memory is a dynamic random access memory (DRAM).

11. The computer rapid boot system of claim 8, wherein the computer boot information includes a plurality of boot files, entry files, active files or relation files of an operating system.

12. The computer rapid boot system of claim 8, wherein the boot information is a boot image file.

13. The computer rapid boot system of claim 12, wherein the computer boot information stored in the main memory is transformed into the boot image file according to the status of the computer boot.

14. The computer rapid boot system of claim 8, further comprising a basic input output system (BIOS) for designating the volatile memory as a computer boot device.

15. A computer rapid boot method comprising:
providing a volatile memory and a power source to store computer boot information;
providing an interface converter for converting the format of a transmission signal between the volatile memory and a transmission interface;
reading the computer boot information stored in the volatile memory via the transmission interface and the interface converter, and then enabling the computer boot information to be stored in the main memory; and
executing the computer boot information stored in the main memory for booting the computer.

16. The computer rapid boot method of claim 15, wherein the computer boot information includes a plurality of boot files, entry files, active files or relation files of an operating system.

17. The computer rapid boot method of claim 15, wherein the boot information is a boot image file.

18. The computer rapid boot method of claim 17, wherein the computer boot information stored in the main memory is transformed into the boot image file according to the status of the computer boot.

19. The computer rapid boot method of claim 15, further comprising:
designating the volatile memory as a computer boot device through a basic input output system (BIOS).

20. The computer rapid boot method of claim 15, further comprising:
transforming the computer boot information stored in the main memory as the boot image file in shutdown;
storing the boot image file in the volatile memory.

21. The computer rapid boot method of claim 15, further comprising:
storing a plurality of boot files, entry files, active files or relation files of an operating system in the volatile memory in shutdown.

22. A computer rapid boot method comprising:
providing a volatile memory and a power source to store computer boot information;
providing an interface converter for converting the format of a transmission signal between the volatile memory and a disk array controller, wherein the disk array controller controls signal transmission of a plurality of transmission interfaces;
reading the computer boot information stored in the volatile memory via the transmission interfaces, the disk array controller and the interface converter, and then enabling the computer boot information to be stored in the main memory; and
executing the computer boot information stored in the main memory for booting the computer.

23. The computer rapid boot method of claim 22, wherein the computer boot information includes a plurality of boot files, entry files, active files or relation files of an operating system.

24. The computer rapid boot method of claim 22, wherein the boot information is a boot image file.

25. The computer rapid boot method of claim 24, wherein the boot image file is transformed from the computer boot information stored in the main memory according to the status of the computer boot.

26. The computer rapid boot method of claim 22, further comprising:
designating the volatile memory as a computer boot device through a basic input output system (BIOS).

27. The computer rapid boot method of claim 22, further comprising:
transforming the computer boot information stored in the main memory into the boot image file when shutting down the computer;
storing the boot image file in the volatile memory.

28. The computer rapid boot method of claim 22, further comprising:
storing a plurality of boot files, entry files, active files or relation files of an operating system in the volatile memory when shutting down the computer.
